(19) United States
(12) Patent Application Publication
(10) Pub. No.: US 2014/0173524 A1
(43) Pub. Date: Jun. 19, 2014

(54) TARGET AND PRESS NATURAL USER INPUT

(71) Applicant: MICROSOFT CORPORATION, Redmond, WA (US)

(72) Inventors: Mark Schwesinger, Bellevue, WA (US); David Bastien, Kirkland, WA (US); Oscar Murillo, Redmond, WA (US); Oscar Kozlowski, Seattle, WA (US); Richard Bailey, Seattle, WA (US); Julia Schwarz, Pittsburgh, PA (US)

(73) Assignee: MICROSOFT CORPORATION, Redmond, WA (US)

(21) Appl. No.: 13/715,686

(22) Filed: Dec. 14, 2012

(51) Int. Cl. G06F 3/0484

(52) U.S. Cl. CPC G06F 3/04842
USPC 715/856

(57) ABSTRACT

A cursor is moved in a user interface based on a position of a joint of a virtual skeleton modeling a human subject. If a cursor position engages an object in the user interface, and all immediately-previous cursor positions within a mode-testing period are located within a timing boundary centered around the cursor position, operation in a pressing mode commences. If a cursor position remains within a constraining shape and exceeds a threshold z-distance while in the pressing mode, the object is activated.

### BACKGROUND

Selection and activation of objects in a graphical user interface via natural user input is difficult. Users are naturally inclined to select an object by performing a pressing gesture, but often accidentally press in an unintended direction. This can result in unintentional disengagement and/or erroneous selections.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments for targeting and selecting objects in a graphical user interface via natural user input are presented. In one embodiment, a virtual skeleton models a human subject imaged by a depth camera. A cursor in a user interface is moved based on the position of a joint of the virtual skeleton. The user interface includes an object pressable in a pressing mode but not in a targeting mode. If a cursor position engages the object, and all immediately-previous cursor positions within a mode-testing period are located within a timing boundary centered around the cursor position, operation transitions to the pressing mode. If a cursor position engages the object but one or more immediately-previous cursor positions within the mode-testing period are located outside of the timing boundary, operation continues in the targeting mode.

### BRIEF DESCRIPTION OF THE DRAWINGS

FIG. 1 schematically shows a non-limiting example of a control environment.

FIG. 2 schematically shows an example of a simplified skeletal tracking pipeline of a depth analysis system.

FIG. 3 shows a method for receiving and interpreting press gestures as natural user input.

FIG. 4 schematically shows an example of a scenario in which an operating mode is determined.

FIG. 5 schematically shows an example of a constraining shape according to an embodiment of the present disclosure.

FIG. 6 schematically shows a modified example of the constraining shape of FIG. 5 according to an embodiment of the present disclosure.

FIG. 7 schematically shows an example of a graphical user interface according to an embodiment of the present disclosure.

FIG. 8 schematically shows a non-limiting example of a computing system for receiving and interpreting press input in accordance with the present disclosure.

### DETAILED DESCRIPTION

The present disclosure is directed to targeting and pressing of objects in a natural user interface. As described in more detail below, natural user input gestures may be bifurcated into target and press modes of operation. The intention of a user to press an object is assessed as the user briefly hesitates before beginning a press gesture. Once this intention is recognized, the operating mode transitions from a targeting mode to a pressing mode, and measures are taken to help the user complete the press without sliding off the object.

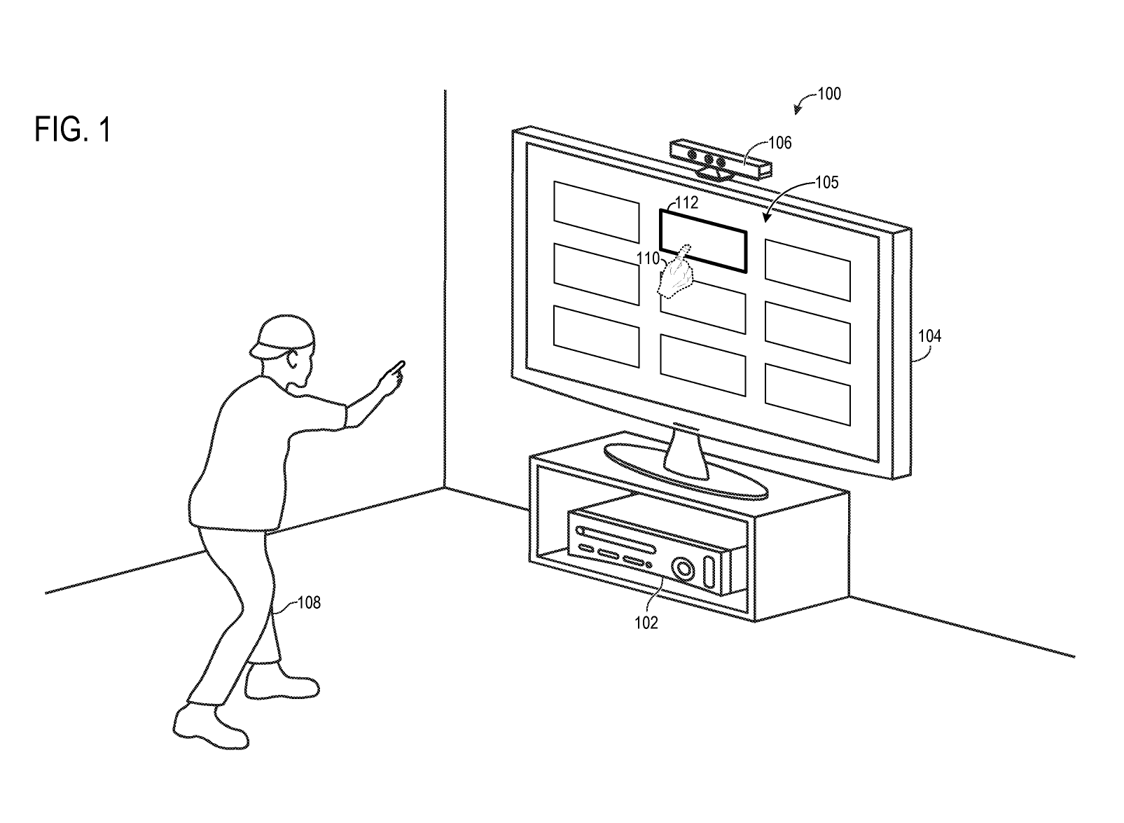

FIG. 1 shows a non-limiting example of a control environment 100. In particular, FIG. 1 shows an entertainment system 102 that may be used to play a variety of different games, play one or more different media types, and/or control or manipulate non-game applications and/or operating systems. FIG. 1 also shows a display device 104 such as a television or a computer monitor, which may be used to present media content, game visuals, etc., to users. As one example, display device 104 may be used to visually present media content received by entertainment system 102. In the example illustrated in FIG. 1, display device 104 is displaying a pressable user interface 105 received from entertainment system 102. In the illustrated example, pressable user interface 105 presents selectable information about media content received by entertainment system 102. The control environment 100 may include a capture device, such as a depth camera 106 that visually monitors or tracks objects and users within an observed scene.

Display device 104 may be operatively connected to entertainment system 102 via a display output of the entertainment system. For example, entertainment system 102 may include an HDMI or other suitable wired or wireless display output. Display device 104 may receive video content from entertainment system 102, and/or it may include a separate receiver configured to receive video content directly from a content provider.

The depth camera 106 may be operatively connected to the entertainment system 102 via one or more interfaces. As a non-limiting example, the entertainment system 102 may include a universal serial bus to which the depth camera 106 may be connected. Depth camera 106 may be used to recognize, analyze, and/or track one or more human subjects and/or objects, such as user 108, within a physical space. Depth camera 106 may include an infrared light to project infrared light onto the physical space and a depth camera configured to receive infrared light.

Entertainment system 102 may be configured to communicate with one or more remote computing devices, not shown in FIG. 1. For example, entertainment system 102 may receive video content directly from a broadcaster, third party media delivery service, or other content provider. Entertainment system 102 may also communicate with one or more remote services via the Internet or another network, for example in order to analyze image information received from depth camera 106.

While the embodiment depicted in FIG. 1 shows entertainment system 102, display device 104, and depth camera 106 as separate elements, in some embodiments one or more of the elements may be integrated into a common device.

One or more aspects of entertainment system 102 and/or display device 104 may be controlled via wireless or wired control devices. For example, media content output by entertainment system 102 to display device 104 may be selected based on input received from a remote control device, computing device (such as a mobile computing device), hand-held game controller, etc. Further, in embodiments elaborated below, one or more aspects of entertainment system 102 and/or display device 104 may be controlled based on natural user input, such as gesture commands performed by a user and interpreted by entertainment system 102 based on image information received from depth camera 106.

FIG. 1 shows a scenario in which depth camera 106 tracks user 108 so that the movements of user 108 may be interpreted by entertainment system 102. In particular, the movements of user 108 are interpreted as controls that can be used to control a cursor 110 displayed on display device 104 as part of pressable user interface 105. In addition to using his movements to control cursor movement, user 108 may select information presented in pressable user interface 105, for example by activating object 112.

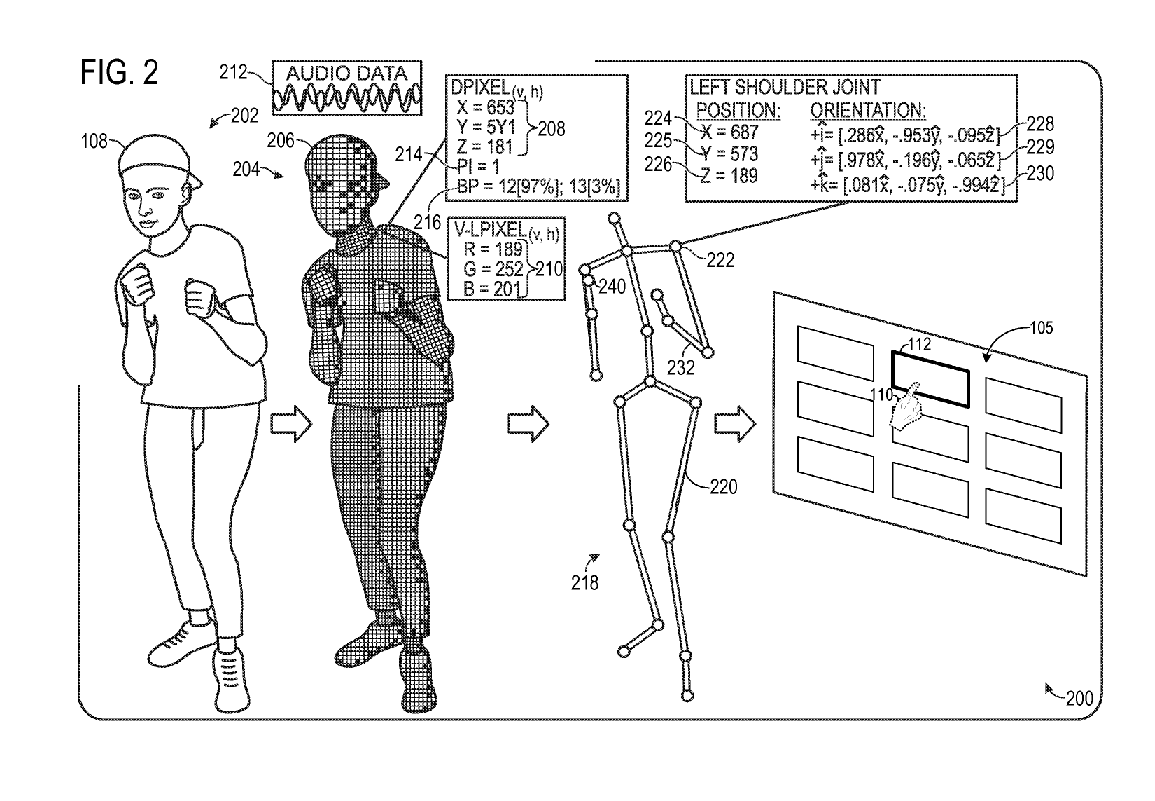

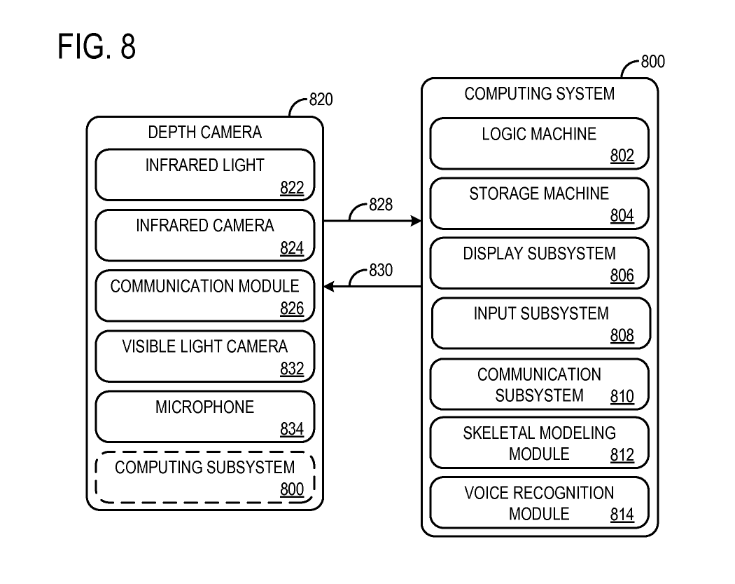

FIG. 2 graphically shows a simplified skeletal tracking pipeline 200 of a depth analysis system that may be used to track and interpret movements of user 108. For simplicity of explanation, skeletal tracking pipeline 200 is described with reference to entertainment system 102 and depth camera 106 of FIG. 1. However, skeletal tracking pipeline 200 may be implemented on any suitable computing system without departing from the scope of this disclosure. For example, skeletal tracking pipeline 200 may be implemented on computing system 800 of FIG. 8. Furthermore, skeletal tracking pipelines that differ from skeletal tracking pipeline 200 may be used without departing from the scope of this disclosure.

At 202, FIG. 2 shows user 108 from the perspective of a tracking device. The tracking device, such as depth camera 106, may include one or more sensors that are configured to observe a human subject, such as user 108.

At 204, FIG. 2 shows a schematic representation 206 of the observation data collected by a tracking device, such as depth camera 106. The types of observation data collected will vary depending on the number and types of sensors included in the tracking device. In the illustrated example, the tracking device includes a depth camera, a visible light (e.g., color) camera, and a microphone.

The depth camera may determine, for each pixel of the depth camera, the depth of a surface in the observed scene relative to the depth camera. A three-dimensional x/y/z coordinate may be recorded for every pixel of the depth camera. FIG. 2 schematically shows the three-dimensional x/y/z coordinates 208 observed for a DPixel[v,h] of a depth camera. Similar three-dimensional x/y/z coordinates may be recorded for every pixel of the depth camera. The three-dimensional x/y/z coordinates for all of the pixels collectively constitute a depth map. The three-dimensional x/y/z coordinates may be determined in any suitable manner without departing from the scope of this disclosure. Example depth finding technologies are discussed in more detail with reference to FIG. 8.

The visible-light camera may determine, for each pixel of the visible-light camera, the relative light intensity of a surface in the observed scene for one or more light channels (e.g., red, green, blue, grayscale, etc.). FIG. 2 schematically shows the red/green/blue color values 210 observed for a V-LPixel[v,h] of a visible-light camera. Red/green/blue color values may be recorded for every pixel of the visible-light camera. The red/green/blue color values for all of the pixels collectively constitute a digital color image. The red/green/blue color values may be determined in any suitable manner without departing from the scope of this disclosure. Example color imaging technologies are discussed in more detail with reference to FIG. 8.

The depth camera and visible-light camera may have the same resolutions, although this is not required. Whether the cameras have the same or different resolutions, the pixels of the visible-light camera may be registered to the pixels of the depth camera. In this way, both color and depth information may be determined for each portion of an observed scene by considering the registered pixels from the visible light camera and the depth camera (e.g., V-LPixel[v,h] and DPixel[v,h]).

One or more microphones may determine directional and/or non-directional sounds coming from user 108 and/or other sources. FIG. 2 schematically shows audio data 212 recorded by a microphone. Audio data may be recorded by a microphone of depth camera 106. Such audio data may be determined in any suitable manner without departing from the scope of this disclosure. Example sound recording technologies are discussed in more detail with reference to FIG. 8.

The collected data may take the form of virtually any suitable data structure(s), including but not limited to one or more matrices that include a three-dimensional x/y/z coordinate for every pixel imaged by the depth camera, red/green/blue color values for every pixel imaged by the visible-light camera, and/or time resolved digital audio data. User 108 may be continuously observed and modeled (e.g., at 30 frames per second). Accordingly, data may be collected for each such observed frame. The collected data may be made available via one or more Application Programming Interfaces (APIs) and/or further analyzed as described below.

The depth camera 106, entertainment system 102, and/or a remote service may analyze the depth map to distinguish human subjects and/or other targets that are to be tracked from non-target elements in the observed depth map. Each pixel of the depth map may be assigned a user index 214 that identifies that pixel as imaging a particular target or non-target element. As an example, pixels corresponding to a first user can be assigned a user index equal to one, pixels corresponding to a second user can be assigned a user index equal to two, and pixels that do not correspond to a target user can be assigned a user index equal to zero. Such user indices may be determined, assigned, and saved in any suitable manner without departing from the scope of this disclosure.

The depth camera 106, entertainment system 102, and/or remote service optionally may further analyze the pixels of the depth map of user 108 in order to determine what part of the user's body each such pixel is likely to image. Each pixel of the depth map with an appropriate user index may be assigned a body part index 216. The body part index may include a discrete identifier, confidence value, and/or body part probability distribution indicating the body part, or parts, to which that pixel is likely to image. Body part indices may be determined, assigned, and saved in any suitable manner without departing from the scope of this disclosure.

At 218, FIG. 2 shows a schematic representation of a virtual skeleton 220 that serves as a machine-readable representation of user 108. Virtual skeleton 220 includes twenty virtual joints—{head, shoulder center, spine, hip center, right shoulder, right elbow, right wrist, right hand, left shoulder, left elbow, left wrist, left hand, right hip, right knee, right ankle, right foot, left hip, left knee, left ankle, and left foot}. This twenty joint virtual skeleton is provided as a non-limiting example. Virtual skeletons in accordance with the present disclosure may have virtually any number of joints.

The various skeletal joints may correspond to actual joints of user 108, centroids of the user's body parts, terminal ends of the user's extremities, and/or points without a direct anatomical link to the user. Each joint may have at least three degrees of freedom (e.g., world space x, y, z). As such, each joint of the virtual skeleton is defined with a three-dimensional position. For example, a left shoulder virtual joint 222 is defined with an x coordinate position 224, a y coordinate position 225, and a z coordinate position 226. The position of the joints may be defined relative to any suitable origin. As one example, the depth camera may serve as the origin, and all joint positions are defined relative to the depth camera. Joints may be defined with a three-dimensional position in any suitable manner without departing from the scope of this disclosure.

A variety of techniques may be used to determine the three-dimensional position of each joint. Skeletal fitting techniques may use depth information, color information, body part information, and/or prior trained anatomical and kinetic information to deduce one or more skeleton(s) that closely model a human subject. As one non-limiting example, the above described body part indices may be used to find a three-dimensional position of each skeletal joint.

A joint orientation may be used to further define one or more of the virtual joints. Whereas joint positions may describe the position of joints and virtual bones that span between joints, joint orientations may describe the orientation of such joints and virtual bones at their respective positions. As an example, the orientation of a wrist joint may be used to describe if a hand located at a given position is facing up or down.

Joint orientations may be encoded, for example, in one or more normalized, three-dimensional orientation vector(s). The orientation vector(s) may provide the orientation of a joint relative to the depth camera or another reference (e.g., another joint). Furthermore, the orientation vector(s) may be defined in terms of a world space coordinate system or another suitable coordinate system (e.g., the coordinate system of another joint). Joint orientations also may be encoded via other means. As non-limiting examples, quaternions and/or Euler angles may be used to encode joint orientations.

FIG. 2 shows a non-limiting example in which left shoulder joint 222 is defined with orthonormal orientation vectors 228, 229, and 230. In other embodiments, a single orientation vector may be used to define a joint orientation. The orientation vector(s) may be calculated in any suitable manner without departing from the scope of this disclosure.

Joint positions, orientations, and/or other information may be encoded in any suitable data structure(s). Furthermore, the position, orientation, and/or other parameters associated with any particular joint may be made available via one or more APIs.

As seen in FIG. 2, virtual skeleton 220 may optionally include a plurality of virtual bones (e.g. a left forearm bone 232). The various skeletal bones may extend from one skeletal joint to another and may correspond to actual bones, limbs, or portions of bones and/or limbs of the user. The joint orientations discussed herein may be applied to these bones. For example, an elbow orientation may be used to define a forearm orientation.

The virtual skeleton may be used to recognize one or more gestures performed by user 108. As a non-limiting example, one or more gestures performed by user 108 may be used to control the position of cursor 110, and the virtual skeleton may be analyzed over one or more frames to determine if the one or more gestures have been performed. For example, a position of a hand joint of the virtual skeleton may be determined, and cursor 110 may be moved based on the position of the hand joint. It is to be understood, however, that a virtual skeleton may be used for additional and/or alternative purposes without departing from the scope of this disclosure.

As explained previously, the position of cursor 110 within pressable user interface 105 may be controlled in order to facilitate interaction with one or more objects presented in pressable user interface 105.

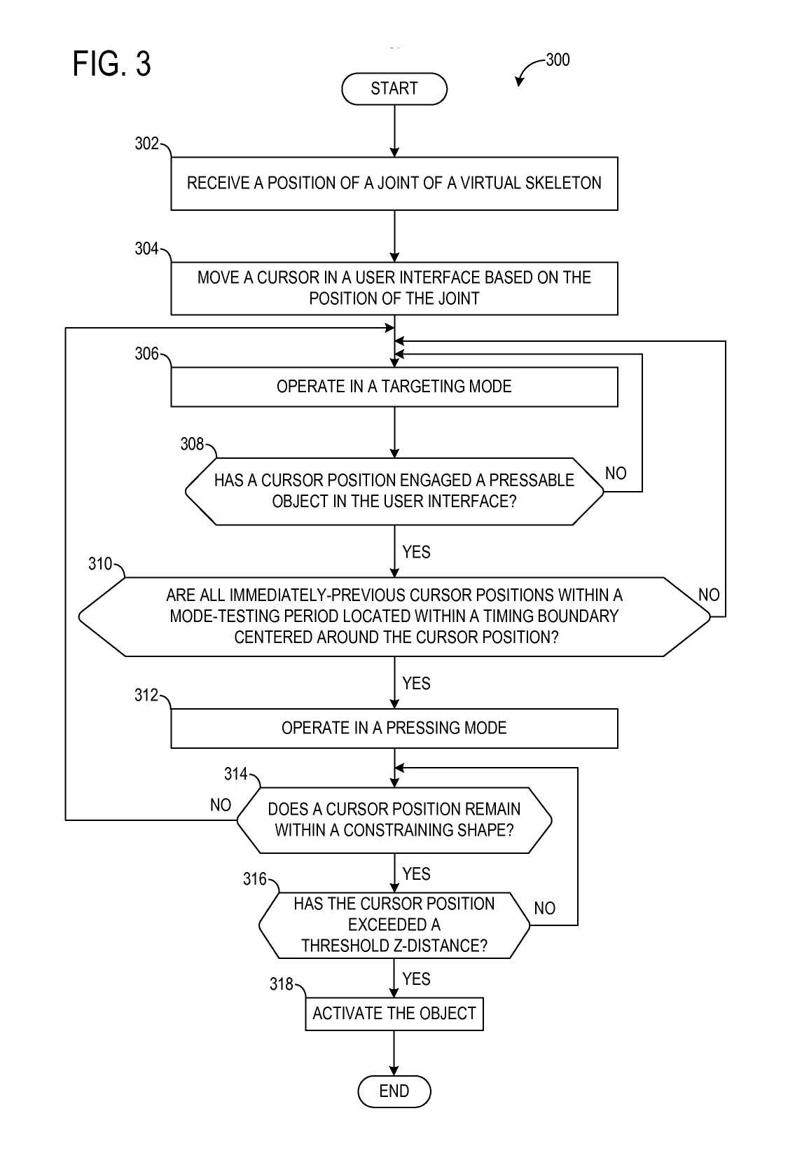

FIG. 3 shows a method 300 for receiving and interpreting press gestures as natural user input. Method 300 may be carried out, for example, by entertainment system 102 of FIG. 1 or computing system 800 of FIG. 8. At 302, a position of a joint of a virtual skeleton is received. As described above with reference to FIG. 2, a position of hand joint 240 of virtual skeleton 220 may be received. The position of the left and/or right hand can be used without departing from the scope of this disclosure. Right hand joint 240 is used as an example, but is in no way limiting. In other embodiments, the position of a head joint, elbow joint, knee joint, foot joint, or other joint may be used. In some embodiments, positions from two or more different joints may be used to move the cursor.

At 304, a cursor in a user interface is moved based on the position of the hand joint. As described above with reference to FIGS. 1 and 2, cursor 110 in pressable user interface 105 may be moved based on the position of hand joint 240.

At 306, method 300 operates in a targeting mode, described in further detail below. Method 300 then proceeds to 308 where it is determined if a cursor position has engaged a pressable object in the user interface. “Engaging” an object as used herein refers to a cursor position corresponding to a pressable region (e.g., object 112) in pressable user interface 105. If the cursor position has not engaged an object, method 300 returns to 306. If the cursor position has engaged an object, method 300 proceeds to 310.

At 310, it is determined if all immediately-previous cursor positions within a mode-testing period are located within a timing boundary centered around the cursor position.

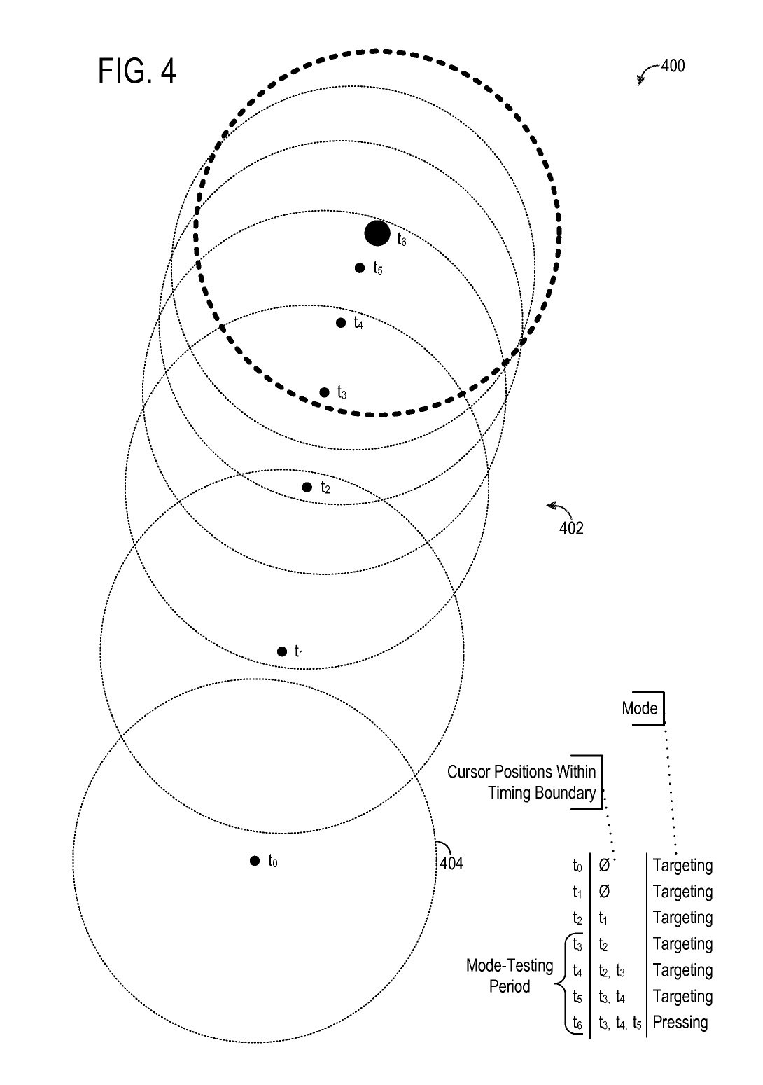

FIG. 4 illustrates an exemplary scenario 400 in which an operating mode is determined responsive to the position of cursor 110, and further illustrates the formation and evaluation of timing boundaries centered around cursor positions.

Example scenario 400 illustrates a set of seven successive cursor positions in cursor position set 402: {t₀, t₁, t₂, t₃, t₄, t₅, and t₆}. t₀ is the first cursor position determined in cursor position set 402. At this time, the system is in a targeting mode. The targeting mode allows user 108 to move among objects displayed in pressable user interface 105 without committing to interaction or activation of the objects.

Upon receiving cursor position t₀, a timing boundary 404 is formed and centered around cursor position t₀. In this example, timing boundaries are formed and cursor positions evaluated in an x-y plane, which may for example correspond to the x-y plane formed by display device 104. In other implementations, different planes may be used. In still other implementations, the timing boundary may be a three-dimensional shape. Timing boundary 404 is not displayed in pressable user interface 105 and is thus invisible to user 108. In some approaches, a timing boundary is formed if its respective cursor position has engaged an object. Other approaches are possible, however, without departing from the scope of this disclosure.

Provided user 108 has engaged an object, timing boundary 404 is examined to determine if all immediately-previous cursor positions within a mode-testing period are located within its boundary. Such an approach facilitates determining whether or not user 108 has hesitated on an object, the hesitation restricting cursor positions to a region in pressable user interface 105. The mode-testing period establishes a duration limiting the number of cursor positions which are evaluated. As one non-limiting example, the mode-testing period is 250 milliseconds, though this value may be tuned to various parameters including user preference, and may be varied to control the time before a transition to a pressing mode is made.

Both the shape and size of timing boundary 404 may be adjusted based on criteria including object size and/or shape, display screen size, and user preference. Further, such size may vary as a function of the resolution of a tracking device (e.g., depth camera 106) and/or display device (e.g., display 104). Although timing boundary 404 is circular in the example shown, virtually any shape or geometry may be used. The circular shape shown may be approximated by a plurality of packed hexagons, for example. Adjusting the size of timing boundary 404 may control the ease and/or speed with which entry into the pressing mode is initiated. For example, increasing the size of timing boundary 404 may allow for larger spatial separations between successive cursor positions that still trigger entry into the pressing mode.

Because cursor position t₀ is the first cursor position determined in cursor position set 402, no immediately-previous cursor positions reside within its boundary. As such, the system continues to operate in the targeting mode. Cursor position t₁ is then received and its timing boundary formed and evaluated, causing continued operation in the targeting mode as with cursor position t₀. Cursor position t₂ is then received and its timing boundary formed and evaluated, which contains previous cursor position t₁. However, in this example the mode-testing period is set such that four total cursor positions (e.g., current+three immediately-previous) are required to be found within a single timing boundary to trigger operation in the pressing mode. As this requirement is not satisfied, operation continues in the targeting mode.

Operation in the targeting mode continues as cursor positions t₃, t₄, and t₅ are received and their timing boundaries formed and evaluated, as all immediately-previous cursor positions within the mode-testing period are not located within any of their timing boundaries. At t₆, operation in the pressing mode is commenced as its timing boundary contains all immediately-previous cursor positions within the mode-testing period—namely, t₃, t₄, and t₅. FIG. 4 shows in table form each cursor position, previous cursor positions located within each timing boundary, and the resulting operating mode.

Returning to FIG. 3, if at 310 all immediately-previous cursor positions within the mode-testing period are not located within a timing boundary centered around the cursor position, method 300 returns to 306 and operates in the targeting mode. If, on the other hand, all immediately-previous cursor positions within the mode-testing period are located within the timing boundary centered around the cursor position, method 300 proceeds to 312 and operates in the pressing mode. The above described technique is a nonlimiting example of assessing user hesitation that can be inferred to signal, in the mind of the user, a switch from a targeting mode to a pressing mode. However, it is to be understood that other techniques for assessing a hesitation are within the scope of this disclosure.

Method 300 then proceeds to 314 where it is determined if a cursor position remains within a constraining shape.

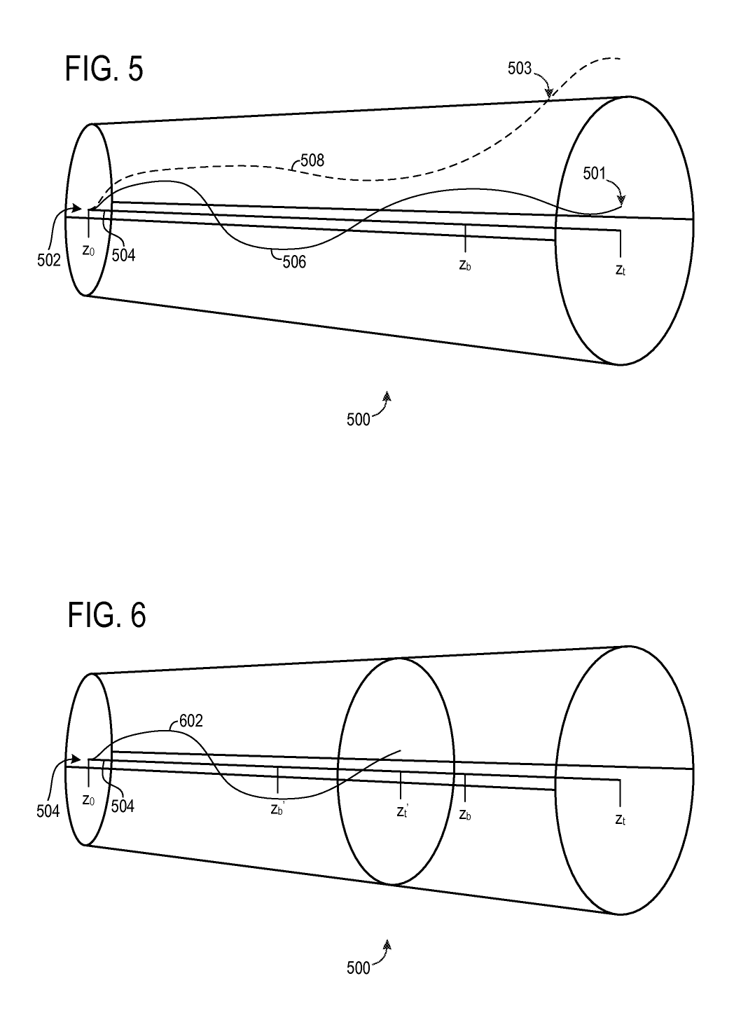

Turning now to FIG. 5, an exemplary constraining shape 500 is shown. Constraining shape 500 is formed upon entry into the pressing mode and facilitates activation of objects displayed in pressable user interface 105. “Activation” as used herein refers to the execution of instructions or other code associated with an object designed to be interacted with by a user.

Upon entry into the pressing mode, constraining shape 500 optionally is formed around and extends from the timing boundary which caused operation in the pressing mode (e.g., the timing boundary corresponding to cursor position t₆), hereinafter referred to as the “mode-triggering timing boundary”. In other words, origin 502, from which constraining shape 500 originates at a point z0, corresponds to the center of the mode-triggering timing boundary. In other embodiments, the constraining shape is not an extension of the timing boundary.

In the example shown in FIG. 5, constraining shape 500 includes a truncated cone having a radius that increases as a function of a z-distance in a z-direction 504. Z-direction 504 may correspond to a direction substantially perpendicular to display device 104 and/or parallel with an optical axis of depth camera 106. The mode-triggering timing boundary optionally may form the base of the truncated cone whose center is the point z0.

Returning to FIG. 3, at 314 it is determined if a cursor position remains within the constraining shape as the cursor position moves responsive to a changing position of the hand joint of the virtual skeleton. If the cursor position does not remain within the constraining shape, method 300 returns to 306, resuming operation in the targeting mode. If the cursor position does remain within the constraining shape, method 300 proceeds to 316 where it is determined if the cursor position has exceeded a threshold z-distance.

Turning back to FIG. 5, constraining shape 500 establishes a three-dimensional region and boundary which restricts the cursor positions with which an object displayed in pressable user interface 105 may be activated. An activating cursor path 506 represents a plurality of cursor positions which together form a substantially continuous path extending forward in z-direction 504 while remaining inside constraining shape 500. At 501, a final cursor position is received which both resides within constraining shape 500 and has a z-distance exceeding a threshold z-distance zt. As such, the system recognizes a completed press and activates the pressed object.

FIG. 5 also shows a disengaging cursor path 508 having that leaves constraining shape 500 at 503 before exceeding the threshold z-distance zt. Unlike above, the system interprets this set of cursor positions as an attempt to disengage the object over which the mode-triggering timing boundary and/or constraining shape are disposed. Thus, operation in the pressing mode is ceased, returning operation to the targeting mode.

In this way, user 108 may engage and activate objects presented in pressable user interface 105 while maintaining the option to disengage before activation. Because constraining shape 500 includes a cone having a radius that increases along z-direction 504, a tolerance is provided allowing user 108 to drift in x and y directions as press input is supplied. Put another way, the region in the x-y plane corresponding to continued operation in the pressing mode is increased beyond what would otherwise be provided by a timing boundary alone.

Although constraining shape 500 is shown in FIG. 5 as including a truncated cone, it will be appreciated that any suitable geometry may be used, including rectangular and truncated pyramidal shapes. Further, any suitable linear or nonlinear functions may control the shape of one or more dimensions of a constraining shape.

FIG. 5 illustrates how cursors (e.g., cursor 110) displayed in pressable user interface 105 may be moved based on a number of different functions which may depend on the operating mode. For example, a cursor may be moved based on a first function while in the targeting mode and moved based on a second function while in the pressing mode. FIG. 5 illustrates an example of moving a cursor based on a second function while in the pressing mode. In particular, once a z-distance of a cursor position represented by activating cursor path 506 exceeds a threshold biasing distance zb, the second function is applied to cursor 110. In this example, the second function includes biasing the position of cursor 110 toward the center of the engaged object. Such biasing may be applied iteratively and continuously such that it is easier for user 108 to smoothly press toward the center of the engaged object as press input advances forward along z-direction 504. It will be appreciated, however, that any suitable functions may be used to move a cursor without departing from the scope of this disclosure, which may or may not depend on the operating mode.

In the example shown in FIG. 5, the threshold z-distance zt is a fixed value. More specifically, this distance is fixed in relation to origin 502, and to the mode-triggering timing boundary if it corresponds to the smaller base of constraining shape 500. As such, a user must push through this fixed distance every time a press and activation of an object is desired. The fixed distance may be predetermined based on an average of human arm lengths, and may be, as one non-limiting example, six inches. In other embodiments, the threshold z-distance may be variable and determined dynamically.

FIG. 6 shows constraining shape 500 extending along z-direction 504 from origin 502. As shown in FIG. 5, constraining shape 500 includes the threshold z-distance zt and threshold biasing distance zb. In this example, however, constraining shape 500 further includes a reduced threshold z-distance zt′ and a reduced threshold biasing distance zb′. A reduced cursor path 602 shows how threshold distances controlling object activation may be varied. Reduced cursor path 602 traverses a reduced length to reach the reduced threshold z-distance zt′ and activate an object. Similarly, biasing of cursor 110 occurs at the reduced threshold biasing distance zb′. Both threshold distances zt and zb may be reduced or lengthened dynamically, and may be modified based on user 108.

In one approach, the threshold z-distance zt may be dynamically set based on the position of a hand joint of a virtual skeleton associated with user 108 when transitioning from the targeting mode to the pressing mode. Hand joint 240 of virtual skeleton 220, for example, may be used to set this distance. The absolute world space position of hand joint 240 may be used, or, its position relative to another object may be evaluated. In the latter approach, the position of hand joint 240 may be evaluated relative to that of shoulder joint 222. Such a protocol may allow the system to obtain an estimate of the degree to which the pointing arm of user 108 is extended. The threshold z-distance zt may be determined in response—for example, if the pointing arm of user 108 is already substantially extended, zt may be reduced, requiring user 108 to move less distance along z-direction 504. In this way, the system may dynamically accommodate the characteristics and disposition of a user's body without making object activation burdensome. It will be appreciated, however, that any other joint in virtual skeleton 220 may be used to dynamically set threshold distances.

The system may undertake additional actions to enhance the user experience when in the pressing mode. In one embodiment, a transition from the pressing mode to the targeting mode will occur if a z-distance of a cursor position fails to increase within a press-testing period. Depending on the duration of the press-testing period, such an approach may require that substantially continuous forward progress along z-direction 504 be supplied by user 108.

Alternatively or additionally, the threshold z-distance zt may be reset if a z-distance of the cursor position decreases along z-direction 504 while in the pressing mode. In one approach, the threshold z-distance zt may be reduced along z-direction 504 in proportion to the degree of cursor position retraction. In this way, the z-distance required to activate an object may remain consistent, without forcing users to overextend themselves beyond what was initially expected. In some embodiments, the threshold z-distance zt may be dynamically redetermined upon cursor retraction, for example based on the orientation of a hand joint relative to a shoulder joint as described above.

Returning to FIG. 3, if, at 316 the cursor position has not exceeded the threshold z-distance, method 300 returns to 314. If the cursor position has exceeded the threshold z-distance, method 300 proceeds to 318 where the object (e.g., object 112) is activated.

Alternative or additional criteria may be applied when determining what constitutes activation of an object. In some examples, an object is not activated until a cursor position remaining within a constraining shape exceeds a threshold z-distance and subsequently retracts a threshold distance. In such implementations, the cursor position must exceed the threshold z-distance and then retract at least a second threshold distance in the opposite direction. Such criteria may enhance the user experience, as many users are accustomed to retraction after applying a forward press to a physical button.

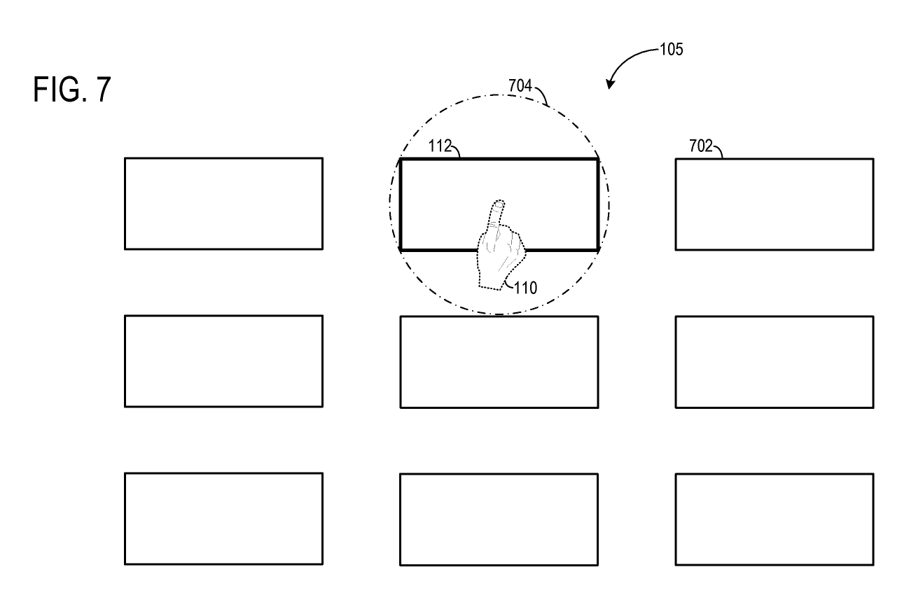

Turning now to FIG. 7, additional scenarios prompting a transition from the pressing mode to the target mode are illustrated. Pressable user interface 105 is shown having a plurality of objects including object 112 and a second object 702. Cursor 110 has engaged object 112 and the pressing mode has been entered. As described above, an indicator may be displayed on an engaged object when operating in the pressing mode, which, in this example, includes a bolded border surrounding object 112. Any suitable indicator may be used. In some embodiments, a transition from the pressing mode to the targeting mode will be carried out if cursor 110 engages a second object other than object 112 to which it is currently engaged—for example, second object 702.

Alternatively or additionally, a transition from the pressing mode to the targeting mode may occur based on the position of cursor 110 relative to a press boundary 704. In this embodiment, press boundary 704 is formed upon entry into the pressing mode and centered on the object to which cursor 110 is engaged. Press boundary 704 provides a two-dimensional boundary in the x and y directions for cursor 110. If, while in the pressing mode, cursor 110 leaves press boundary 704 before exceeding a threshold z-distance (e.g., zt in constraining shape 500), a transition from the pressing mode to the targeting mode occurs. Press boundary 704 may enhance the user experience for embodiments in which the size and geometry of constraining shapes are such that a user may perform a majority of a press only to finish the press on a different object, thus activating that object. Put another way, a constraining shape may be so large as to overlap objects other than the object on which it is centered, benefiting from a press boundary which enhances input interpretation.

In the illustrated example, press boundary 704 is circular with a diameter corresponding to the diagonals of object 90. In other embodiments, press boundaries may be provided with shapes that correspond to the objects on which they are centered.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. Entertainment system 102 may be a non-limiting example of computing system 800. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, steroscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

Further, computing system 800 may include a skeletal modeling module 812 configured to receive imaging information from a depth camera 820 (described below) and identify and/or interpret one or more postures and gestures performed by a user. Computing system 800 may also include a voice recognition module 814 to identify and/or interpret one or more voice commands issued by the user detected via a microphone (coupled to computing system 800 or the depth camera). While skeletal modeling module 812 and voice recognition module 814 are depicted as being integrated within computing system 800, in some embodiments, one or both of the modules may instead be included in the depth camera 820.

Computing system 800 may be operatively coupled to the depth camera 820. Depth camera 820 may include an infrared light 822 and a depth camera 824 (also referred to as an infrared light camera) configured to acquire video of a scene including one or more human subjects. The video may comprise a time-resolved sequence of images of spatial resolution and frame rate suitable for the purposes set forth herein. As described above with reference to FIGS. 1 and 2, the depth camera and/or a cooperating computing system (e.g., computing system 800) may be configured to process the acquired video to identify one or more postures and/or gestures of the user and to interpret such postures and/or gestures as device commands configured to control various aspects of computing system 800, such as scrolling of a scrollable user interface.

Depth camera 820 may include a communication module 826 configured to communicatively couple depth camera 820 with one or more other computing devices. Communication module 826 may include wired and/or wireless communication devices compatible with one or more different communication protocols. In one embodiment, the communication module 826 may include an imaging interface 828 to send imaging information (such as the acquired video) to computing system 800. Additionally or alternatively, the communication module 826 may include a control interface 830 to receive instructions from computing system 800. The control and imaging interfaces may be provided as separate interfaces, or they may be the same interface. In one example, control interface 830 and imaging interface 828 may include a universal serial bus.

The nature and number of cameras may differ in various depth cameras consistent with the scope of this disclosure. In general, one or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the surface imaged by that pixel. ‘Depth’ is defined as a coordinate parallel to the optical axis of the depth camera, which increases with increasing distance from the depth camera.

In some embodiments, depth camera 820 may include right and left stereoscopic cameras. Time-resolved images from both cameras may be registered to each other and combined to yield depth-resolved video.

In some embodiments, a “structured light” depth camera may be configured to project a structured infrared illumination comprising numerous, discrete features (e.g., lines or dots). A camera may be configured to image the structured illumination reflected from the scene. Based on the spacings between adjacent features in the various regions of the imaged scene, a depth map of the scene may be constructed.

In some embodiments, a “time-of-flight” depth camera may include a light source configured to project a pulsed infrared illumination onto a scene. Two cameras may be configured to detect the pulsed illumination reflected from the scene. The cameras may include an electronic shutter synchronized to the pulsed illumination, but the integration times for the cameras may differ, such that a pixel-resolved time-of-flight of the pulsed illumination, from the light source to the scene and then to the cameras, is discernible from the relative amounts of light received in corresponding pixels of the two cameras.

Depth camera 820 may include a visible light camera 832 (e.g., color). Time-resolved images from color and depth cameras may be registered to each other and combined to yield depth-resolved color video. Depth camera 820 and/or computing system 800 may further include one or more microphones 834.

While depth camera 820 and computing system 800 are depicted in FIG. 8 as being separate devices, in some embodiments depth camera 820 and computing system 800 may be included in a single device. Thus, depth camera 820 may optionally include computing system 800.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of receiving user input, the method comprising:
moving a cursor in a user interface based on a position of a joint of a virtual skeleton, the virtual skeleton modeling a human subject imaged with a depth camera, the user interface including an object pressable in a pressing mode but not in a targeting mode;
if a cursor position engages the object, and all immediately-previous cursor positions within a mode-testing period are located within a timing boundary centered around the cursor position, operating in the pressing mode; and
if a cursor position engages the object, and one or more immediately-previous cursor positions within the mode-testing period are located outside of the timing boundary, operating in the targeting mode.

2. The method of claim 1, further comprising activating the object if the cursor position exceeds a threshold z-distance while in the pressing mode.

3. The method of claim 2, wherein the threshold z-distance is a fixed value.

4. The method of claim 2, wherein the joint is a hand joint, and wherein the threshold z-distance is dynamically set based on the position of the hand joint relative to a shoulder joint.

5. The method of claim 1, further comprising transitioning from the pressing mode to the targeting mode if a z-distance of the cursor position fails to increase within a press-testing period.

6. The method of claim 1, wherein the timing boundary is circular.

7. The method of claim 1, wherein the mode-testing period has a 250 millisecond duration.

8. The method of claim 1, wherein moving the cursor further comprises:
moving the cursor based on a first function while in the targeting mode; and
moving the cursor based on a second function while in the pressing mode.

9. The method of claim 8, wherein moving the cursor based on the second function includes biasing the cursor toward a center of the object as a z-distance of the cursor position increases past a threshold biasing distance.

10. A method of receiving user input, the method comprising:
moving a cursor in a user interface based on a position of a hand joint of a virtual skeleton, the virtual skeleton modeling a human subject imaged with a depth camera, the user interface including an object pressable in a pressing mode but not in a targeting mode;
if a cursor position engages the object and hesitates on the object, operating in the pressing mode; and
if a cursor position engages the object but does not hesitate on the object, operating in the targeting mode.

11. A method of receiving user input, the method comprising:
moving a cursor in a user interface based on a position of a hand joint of a virtual skeleton, the virtual skeleton modeling a human subject imaged with a depth camera, the user interface including an object pressable in a pressing mode but not in a targeting mode;
if a cursor position engages the object, and all immediately-previous cursor positions within a mode-testing period are located within a timing boundary centered around the cursor position, operating in the pressing mode;
if a cursor position remains within a constraining shape and exceeds a threshold z-distance while in the pressing mode, activating the object; and
if the cursor position leaves the constraining shape before exceeding the threshold z-distance while in the pressing mode, operating in the targeting mode.

12. The method of claim 11, wherein moving the cursor further comprises:
moving the cursor based on a first function while in the targeting mode; and
moving the cursor based on a second function while in the pressing mode.

13. The method of claim 12, wherein moving the cursor based on the second function includes biasing the cursor toward a center of the object as a z-distance of the cursor position increases past a threshold biasing distance.

14. The method of claim 11, wherein the constraining shape includes a truncated cone having a radius that increases as a function of a z-distance.

15. The method of claim 14, wherein the truncated cone extends from the timing boundary.

16. The method of claim 11, wherein the threshold z-distance is dynamically set based on the position of the hand joint when transitioning from the targeting mode to the pressing mode.

17. The method of claim 11, wherein the threshold z-distance is dynamically set based on the position of the hand joint relative to a shoulder joint.

18. The method of claim 11, wherein the threshold z-distance is a fixed value.

19. The method of claim 11, further comprising transitioning from the pressing mode to the targeting mode if a z-distance of the cursor position fails to increase within a press-testing period.

20. The method of claim 11, further comprising:
if a z-distance of the cursor position decreases while in the pressing mode, resetting the threshold z-distance.
